(19) United States
(12) Patent Application Publication
(10) Pub. No.: US 2003/0023736 A1
(43) Pub. Date: Jan. 30, 2003

(54) Method and system for filtering messages

(76) Inventor: Kurt Abkemeier, Summit, NJ (US)

Correspondence Address: OSTROLENK FABER GERB & SOFFEN, 1180 AVENUE OF THE AMERICAS, NEW YORK, NY, 100368403

(21) Appl. No.: 10/192,482

(22) Filed: Jul. 9, 2002

Related U.S. Application Data
(60) Provisional application No. 60/304,829, filed on Jul. 12, 2001.

(51) Int. Cl. G06F 15/16

(52) U.S. Cl. 709/229; 709/207

(57) ABSTRACT

A method and system for filtering messages by providing a filter for filtering messages based upon an authorization criteria. A message that satisfies the authorization criteria is forwarded to a message receiver, while a message that fails to satisfy the authorization criteria is not forwarded. The unauthorized sender is notified that the message is unauthorized, and provided with an opportunity to attempt to satisfy the authorization criteria. The attempt can be coupled with a mandatory surrender or deposit of a thing of value to permit the unauthorized sender to request authorization from the intended receiver. The intended receiver can accept or reject the attempt by the unauthorized sender, and keep or return the thing of value, such as a monetary amount. The intended receiver can provide pre-authorization for future messages.

This application is based on and claims benefit of U.S. provisional application Ser. No. 60/304,829, filed Jul. 12, 2001 entitled E-MAIL CONDITIONING SUBSCRIPTION SERVICE SYSTEM AND METHOD, to which a claim of priority is hereby made.

### FIELD OF THE INVENTION

The present invention relates generally to the processing, filtering and management of electronic communications.

### BACKGROUND OF THE INVENTION

Electronic mail (“email”) has become a widely used medium upon which people have come to rely on for communicating with one another. Email has several major advantages compared to other physical means of communications, such as sending a letter through the U.S. Postal Service. For example, email is a very low-cost means of distributing messages, allows one to send a message just as easily to thousands of people as it does to one person, and the delivery of the message is almost immediate.

Unfortunately, these advantages make it relatively easy for some people and entities to send out unwanted or unsolicited email (often referred to as “junk-email”) to recipients. As such, recipients of junk-email often waste time and/or money in reviewing and/or deleting such junk-email. Because of this, email users have become vocal in their displeasure of junk-email and legislatures throughout the world have begun enacting laws to restrict the continued proliferation of junk-email.

Additionally, email service providers (“ESP”) have provided some tools for recipients to reduce the amount of junk-email that their account owners receive. Unfortunately, these responses and tools have largely been inadequate to solve the problem of junk-email. The primary problem is that junk-email filters are typically based upon blacklist filters that need to compare messages from a potentially infinite number of sources with a finite number of pre-defined unacceptable message senders. Furthermore, it is not easy to recognize and define what constitutes junk-email, so filters may not be able to accurately process each message appropriately. Despite these actions by the government and email service providers, junk-email has been increasing in magnitude with greater volumes of junk-email being received by email users everyday.

A variety of methods devised to address the problem of junk-email have been described. For example, U.S. Pat. No. 6,249,805 describes the use of a filter in combination with an email server to remove messages that may be considered unwanted by recipients. See also U.S. Pat. Nos. 6,192,114, 6,199,102, 6,192,114, 6,112,227, 6,092,101, 6,023,723, 5,508,817, 6,330,590, 6,324,569, 6,321,267, 6,301,608, 6,266,692, 6,167,434, 6,161,130, 6,052,709, 5,999,968, 5,999,932 and 5,619,648.

Generally, email filtering applications are based on the following three approaches: personal whitelists, personal blacklists or general shared blacklists. While each method has its own strengths, the overriding weaknesses, however, have limited the adoption and effectiveness of each solution.

The personal whitelist filter approach requires an email receiver to input information into a filter, such as a set of email addresses of potential email senders, whose messages the email recipient pre-approves (the “whitelist”). After providing such a filter, all messages from email senders that do not have their email address in the filter, for example, are rejected or placed into separate folder. U.S. Pat. Nos. 6,249,805, 6,192,114, 6,119,102, 6,112,227 and 6,092,101 all use whitelist technology to varying degrees to filter messages. Such whitelist filtering is also available in commonly available email services such as Microsoft Outlook and Hotmail as a junk mail filter option.

Many email receivers may find this approach to be advantageous because they define exactly from whom he/she desires to receive email and only receives emails from those persons. However, because this approach assumes any email address that is not listed in the whitelist is not an email address from which the email receiver would like to receive an email, email that is from desired sources that are not listed in the filter are never delivered to the email receiver's inbox. Because it is near impossible for an email receiver to anticipate all of the email addresses of potential desired email senders, email receivers tend to avoid using the whitelist approach. Simple whitelist-based filters are typically considered too restrictive for practical use.

The personal blacklist approach requires an email receiver to input in into a filter a set of email address of those email senders whose messages the email receiver would like to block (the “blacklist”). All email from email senders whose email addresses are not listed in the filter may pass through and be received in the email receiver's inbox. Email receivers may like this approach because they are able to define only those email addresses from whom he/she does not want to receive email. Such an approach, however, assumes that any email address that is not listed in the blacklist represents the email address of a person from whom the email receiver desires to receive an email, which is not always the case, and increasingly is not the case with the growth of junk-email. For example, junk-email senders (“junk-emailers”) often “tumble” through, or change, email addresses to bypass and defeat personal blacklists to use a “clean” email address that is not on a blacklist. U.S. Pat. No. 6,023,723 uses blacklist filtering technology to varying degrees to filter messages. Such blacklist filtering is also available in commonly available email services such as Hotmail, Yahoo, America Online and Microsoft Outlook through a junk mail filter option.

As a result, email receivers tend to use personal blacklists sparingly because such blacklists are only partially effective in blocking unwanted email, with typical success rates of 25% to 60% in blocking junk-email. Another drawback to this approach is that it is very difficult for an email receiver to anticipate all of the email addresses of junk-emailers and other potential non-legitimate email senders to include in a blacklist filter. Junk-emailers tend to stay one step ahead of blacklist filters because new sender addresses are constantly being generated.

The general shared blacklist approach requires a shared, cooperative listing of known junk-email addresses, internet domain addresses and internet service providers (“ISPs”) that is used by an ESP to promulgate a filter for all email addresses, or components thereof, of those email senders whose messages may be blocked by the ESP (“general shared blacklist”). In the case of a general shared blacklist, filter entries are typically compiled and managed by the ESP or a third-party with little or no knowledge or action required on the behalf of the email receiver. The email receiver typically has no ability to modify any of the entries in the general shared blacklist.

Often, the filtering process of a general shared blacklist is totally transparent to the email receiver in that it requires no filter management by the email receiver. Instead such filter management often falls on those most aware the junk-email problem: email administrators. Such filtering services are provided directly to email users by nearly all ESPs, such as Hotmail, Yahoo, America Online and Earthlink, and companies such as Brightmail and Postini provide the public blacklists to the ESPs to use in its filters and U.S. Pat. No. 6,052,709 addresses public blacklists.

As a result, general shared blacklists have been able to block or discourage many of the less capable junk-emailers. However, smart junk-emailers, e.g., those who can tumble their email addresses or other identifying characteristics that are used as the element upon which a filter operates, can stay a step ahead of a general shared blacklist and get their junk-email to an email receiver. Furthermore, some email addresses are often wrongly included on a general shared blacklist, thereby blocking what may be a desired e-mail source. As a result, email receivers continue to receive junk-email despite the use of general shared blacklists. Similar to the case with personal blacklists, it is very difficult to anticipate all of the email addresses of potential junk-emailers or undesirable email senders to include in a general shared blacklist filter.

The primary problem with these above-mentioned filters based upon the email address of the sender of the message is that it is very difficult to know beforehand the email addresses of all those either from whom one would like to, or would not like to, receive a message. In the case of whitelists, while the number of email addresses of those from whom an email user would be willing to receive a message is probably finite, it is still a large number and it is not practicable to define those email addresses in advance of receiving messages. The inherently restrictive nature of a pure whitelist often makes it more trouble than it is worth to use it. In the case of all types of blacklists, the number of potentially non-legitimate email addresses is extremely large and not predictable. The inherently undefined nature of a pure blacklist often makes it more trouble than it is worth to use it as well.

U.S. Pat. No. 6,192,114 discloses one method that provides a whitelist-based solution that has several drawbacks. First, while it implements a whitelist-based solution, it is too narrow a solution in that authorization is limited to comparing only the source address of the electronic mail communication initiated by a sending party to an authorization list without consideration of other parameters that may improve the filtered result. Second, U.S. Pat. No. 6,192,114 specifies for a fee to be charged to the unauthorized sending party of an electronic mail communication to store the electronic mail communication in an electronic mail box associated with the receiver. Such a solution requires massive storage to be used to store original email messages until unauthorized senders make decisions whether or not to pay a fee for the message to be delivered to, and stored in, the receiver's email inbox. This is not a practical solution considering that the volume of junk-email being sent today is already large and rapidly increasing. Furthermore, the vast majority of junk-email senders will likely never make a decision about whether or not to pay the fee to be charged, so to store those messages until a decision is made by the message sender is complicated by those who never make a decision. Third, such a solution enables any message sender to push any message through to the receiver's inbox as long as a fee is paid. For example, any message sender completely unknown to the message receiver could send through sexually explicit and graphic pictures, attachments, messages and viruses as long as the sender is willing to pay a fee to do so. This makes a message receiver vulnerable to anyone who wants to pay to push a message through without any control over the process.

Lastly, U.S. Pat. No. 6,192,114 simply charges a fee to unauthorized senders for having sent a message. With such a process in place, senders who are unaware of their authorization status may be discouraged from sending messages for fear that they will be charged a fee due to their unauthorized status.

Accordingly, there is a need for an email filtering system that overcomes the above drawbacks to provide a user with an email system that is free from junk email and easily managed and maintained.

### SUMMARY OF THE INVENTION

The present invention provides a system and method for filtering unauthorized messages received by a message recipient while providing an opportunity for senders of unauthorized messages to request authorization. For each message received, it is determined whether or not the message is authorized. Such criteria which defines authorization may include, for example, the name of the sender of the message, an email address of the sender, a screen name of the sender, a telephone number of the sender, the source of the message or the content of the message, all or any of which are compared with or against authorization parameters in an authorization filter as set by a recipient. All authorized messages pass through the authorization filter for retrieval by, or delivery to, the recipient. An unauthorized message causes the generation of an unauthorized message notification to the sender of the message notifying the sender of the unauthorized status of the message.

According to a feature of the present invention, senders without authorization have the option to request authorization and deposit an item of defined value into an escrow account of a receiver as a gesture of “good faith.” As part of the authorization request process, the receiver has the option to keep or return, in whole or in part, anything which was deposited by the unauthorized sender into the receiver's escrow account and to provide authorization or not for future messages, which is then reflected in the authorization filter.

Such a process allows for a filtering messages based upon multiple parameters customizable by individual message receivers. Second, it provides control and an extra level of protection to the message receiver to prevent any message sender from being able to send any message through. Lastly, it provides for a potential zero-cost transaction to the message sender, if the message receiver decides to return the escrow proceeds to the message sender.

### BRIEF DESCRIPTION OF THE DRAWINGS

The invention is described below in detail with reference to the accompanying drawings in which:

FIG. 1 is a diagram showing a communication system between a sender and a receiver according to the present invention;

FIG. 2 is a conceptual diagram of interaction between a sender and a receiver in processing messages;

FIG. 3 is a conceptual diagram of interaction between a sender and a receiver in managing authorization requests;

FIG. 4 is a flowchart and block diagram illustrating an embodiment of present invention; and

FIG. 5 is a flowchart illustrating another embodiment of the present invention.

### DETAILED DESCRIPTION OF THE DRAWINGS

The present invention relates to a system and method for filtering messages intended to be received by a message recipient. The following description is presented to enable one of ordinary skill in the art to make and use the invention and is provided in the context of a patent application and its requirements. Various modifications to the preferred embodiment may be readily apparent to those skilled in the art and the generic principles herein may be applied to other embodiments. Thus, the present invention is not intended to be limited to the embodiment shown, but is to be accorded the widest scope consistent with the principles and features described herein.

Although the present invention may be described in terms of a system that receives email, it is to be understood that email is merely an example in which the present invention can be applied. For instance, the present invention can also be applied to other forms of messages, such as instant messaging, short message service (“SMS”) on wireless devices, wireless email, voicemail and real-time voice communications.

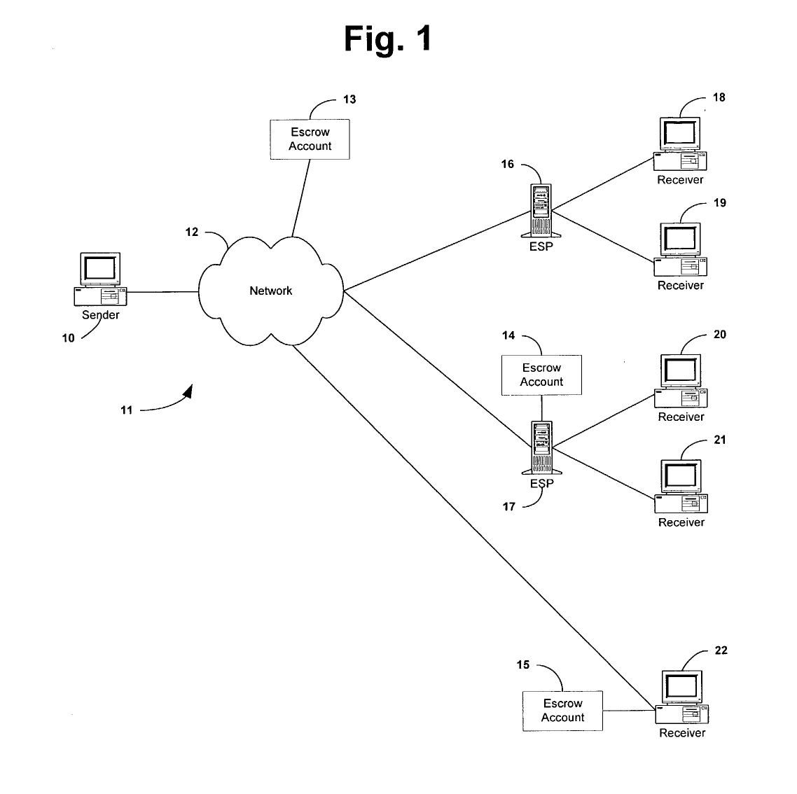

Referring now to FIG. 1, a generalized architecture for a communication system is shown generally as communication system 11. Various communication devices are connected through a switched network 12 to communicate with each other. It should be apparent that switched network 12 can include standard telecommunication systems such as optical, cable, wireless, microwave, satellite, telephone, television and internet, to name a few physical and systematic communication structures. A sender 10 connected to switched network 12 can send messages to numerous receivers including receivers 18, 19, 20, 21 and 22.

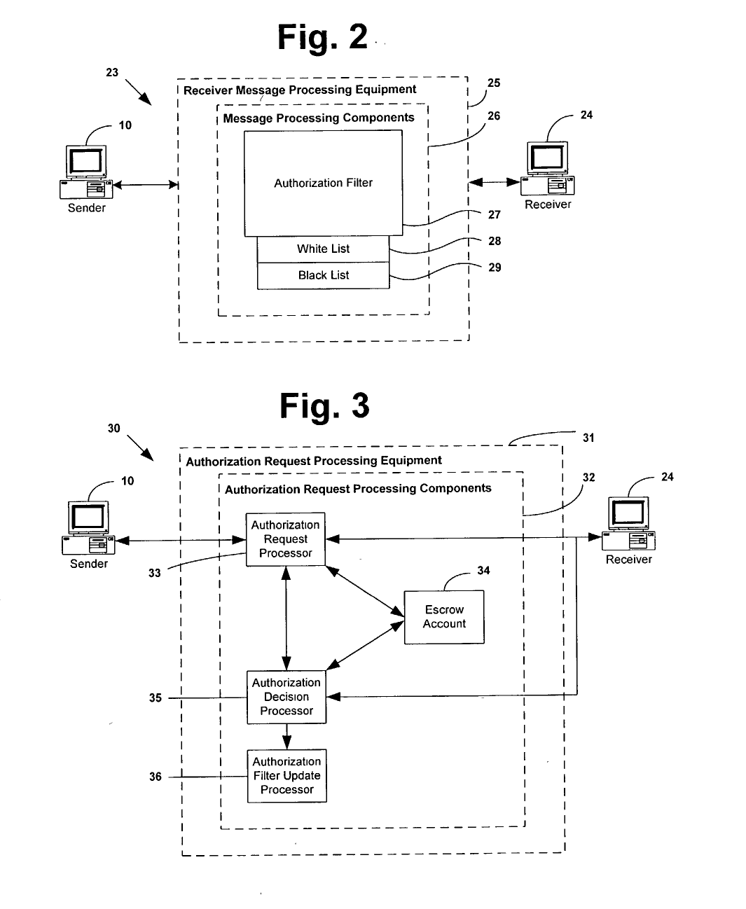

Receivers 18 and 19 are illustrated as being connected to switched network 12 through an Email Service Provider (“ESP”) 16. ESP 16 typically handles message processing for receivers 18 and 19. Escrow account management by a third-party service provider is illustrated by escrow account 13 for receivers 18 and 19. Alternatively, an escrow account 14 or escrow account 15 may handle the escrow capabilities for receivers 18 and 19. It should be apparent that message processing and management capability is not limited to the systems illustrated in FIG. 1, but can also be arranged at a remotely connected location, on a Wide Area Network (“WAN”) or a Local Area Network (“LAN”), through dedicated or proprietary network connections and third parties, to name just a few scenarios. To meet the operative features of the present invention, the message processing and management capability need only by inserted between a sender and receiver any where in a communication path between the two, as illustrated in FIG. 2 and discussed in more detail below.

Receivers 20 and 21 are illustrated as being connected to switched network 12 through an Email Service Provider (“ESP”) 17. ESP 17 typically handles message processing for receivers 20 and 21, and is illustrated as also managing an escrow account 14 for receivers 20 and 21. Alternatively, an escrow account 13 or escrow account 15 may handle the escrow capabilities for receivers 18 and 19. It should be apparent that message processing and management capability is not limited to the systems illustrated in FIG. 1, but can also be arranged at a remotely connected location, on a Wide Area Network (“WAN”) or a Local Area Network (“LAN”), through dedicated or proprietary network connections and third parties, to name just a few scenarios. To meet the operative features of the present invention, the message processing and management capability need only by inserted between a sender and receiver any where in a communication path between the two, as illustrated in FIG. 2 and discussed in more detail below.

Receiver 22 can receive messages from sender 10 directly and have message processing capability located locally. As a feature of the present invention, an escrow account 15 can also be located locally with receiver 22. Alternatively, an escrow account 13 or escrow account 14 may handle the escrow capabilities for receiver 22.

Referring now to FIG. 2, a conceptual organization of a communication system 23 is illustrated. The communication system provides a link between sender 10 and a generalized receiver 24. According to the present invention, a Recipient Message Processing Equipment (“RMPE”) 25 is inserted between sender 10 and receiver 24 to provide message processing and management. RMPE 25 contains or controls message processing components 26, the individual components of which need not be located physically or logically in a same location. Components 26 include an Authorization Filter (“AF”) 27, a white list filter 28 and a black list filter 29

AF 27 processes email sent from sender 10 addressed to receiver 24. The processing of the email is based on the content and settings for white list 28 and black list 29. It should be apparent that AF 27 can utilize any combination of various types of filters that an individual message recipient would like to include to provide pre-authorization. Examples of various filters that make up white list 28 and black list 29 include:

1. Personal sender-based whitelist filter: This is a filter defined and managed by an individual message recipient which includes information defining characteristics of the senders of messages who may be classified as authorized. Typical defining characteristics of the senders of messages may include, but are not limited to, a sender's name, email address, screen name, phone number or IP address. For example, an individual message recipient may define the email address [*authorized*sender*]@[*sender*domain*.com*] to be that of an authorized message sender so that any time the AF processes a message sent by [*authorized*sender*]@[*sender*domain*.com*], the message may be considered authorized.

2. Personal sender-based blacklist filter: This is a filter defined and managed by an individual message recipient which includes information defining characteristics of the senders of messages who may be classified as unauthorized. Typical defining characteristics of the senders of messages may include, but are not limited to, a sender's name, email address, screen name, phone number or IP address. For example, an individual message recipient may define the email address [*unauthorized*sender*]@[*sender*domain*.com*] to be that of an unauthorized message sender so that any time the AF processes a message sent by [*unauthorized*sender*]@[*sender*domain*.com*], the message may be considered unauthorized.

3. Personal content-based blacklist filter: This is a filter defined and managed by an individual message recipient which includes information defining characteristics of the content of the messages who may be classified as unauthorized. Typical defining characterics of the content of the messages may include, but are not limited to, particular text strings defined by the individual message recipient or technical specifications of the message. For example, an individual message recipient may define that any time the text “naked celebrity,” or any text string with a preponderance of the text contained within the defined text string, is included anywhere in the message text, the message may be considered unauthorized.

4. General shared sender-based whitelist filter: This is a filter defined and managed by a party other than the individual message recipient which includes information defining characteristics of the senders of messages who may be classified as authorized. Typical defining characteristics of the senders of messages may include, but are not limited to, a sender's name, email address, screen name, phone number or IP address. For example, a party other than the individual message recipient may define the email address [*authorized*sender*]@[*sender*domain*.com*] to be that of an authorized message sender so that any time the AF processes a message sent by [*authorized*sender*]@[*sender*domain*.com*], the message may be considered authorized.

5. General shared sender-based blacklist filter: This is a filter defined and managed by a party other than the individual message recipient which includes information defining characteristics of the senders of messages who may be classified as unauthorized. Typical defining characteristics of the senders of messages may include, but are not limited to, a sender [symbol] s name, email address, screen name, phone number or IP address. For example, an party other than the individual message recipient may define the email address [*unauthorized*sender*]@[*sender*domain*.com*] to be that of an unauthorized message sender so that any time the AF processes a message sent by [*unauthorized*sender*]@[*sender*domain*.com*], the message may be considered unauthorized.

6. General content-based blacklist filter: This is a filter defined and managed by a party other than the individual message recipient which includes information defining characteristics of the content of the messages who may be classified as unauthorized. Typical defining characterics of the content of the messages may include, but are not limited to, particular text strings defined by the individual message recipient or technical specifications of the message. For example, party other than an individual message recipient may define that any time the text “naked celebrity,” or any text string with a preponderance of the text contained within the defined text string, is included anywhere in the message text, the message may be considered unauthorized.

The operation of communication system 23 and the various aspects of the processes involved will be explained in terms of message flow. Each of the above described filters, or other filtering schemes that are usable with the present invention, can be updated based on interactions between sender 10 and receiver 24 and RMPE 25.

Referring now to FIG. 3, a conceptual organization of an authorization request system 30 is illustrated. The authorization request system provides a link between sender 10 and a generalized receiver 24. According to the present invention, a Authorization Request Processing Equipment (“ARPE”) 31 is inserted between sender 10 and receiver 24 to provide authorization request processing and management. ARPE 31 contains or controls authorization request processing components 32, the individual components of which need not be located physically or logically in a same location. Components 32 include an Authorization Request Processor 33, an Escrow Account 34, an Authorization Decision Processor 35 and an Authorization Filter Update Processor 36.

Authorization Request Processor 33 processes an authorization request from sender 10 for receiver 24. As part of this process, sender 10 is notified of the requirements for requesting authorization specified for receiver 24. As a feature of the present invention, one of the requirements for requesting authorization may include a party placing an item of value into an Escrow Account 34 of the receiver 24.

Upon the sender completing the authorization request, the Authorization Request Processor 33 notifies the receiver 24 of the authorization request from sender 10. The receiver 24 accesses the Authorization Decision Processor 35 which records the decisions made by receiver 24 with respect to the authorization request. The Authorization Filter Update Processor 36 and Escrow Account 34 are updated to reflect the decisions of receiver 24. Lastly, the Authorization Filter Update Processor 36 communicates with Authorization Filter 27 to update the Authorization Filter 27 for any changes which may need to be made to the Authorization Filter 27.

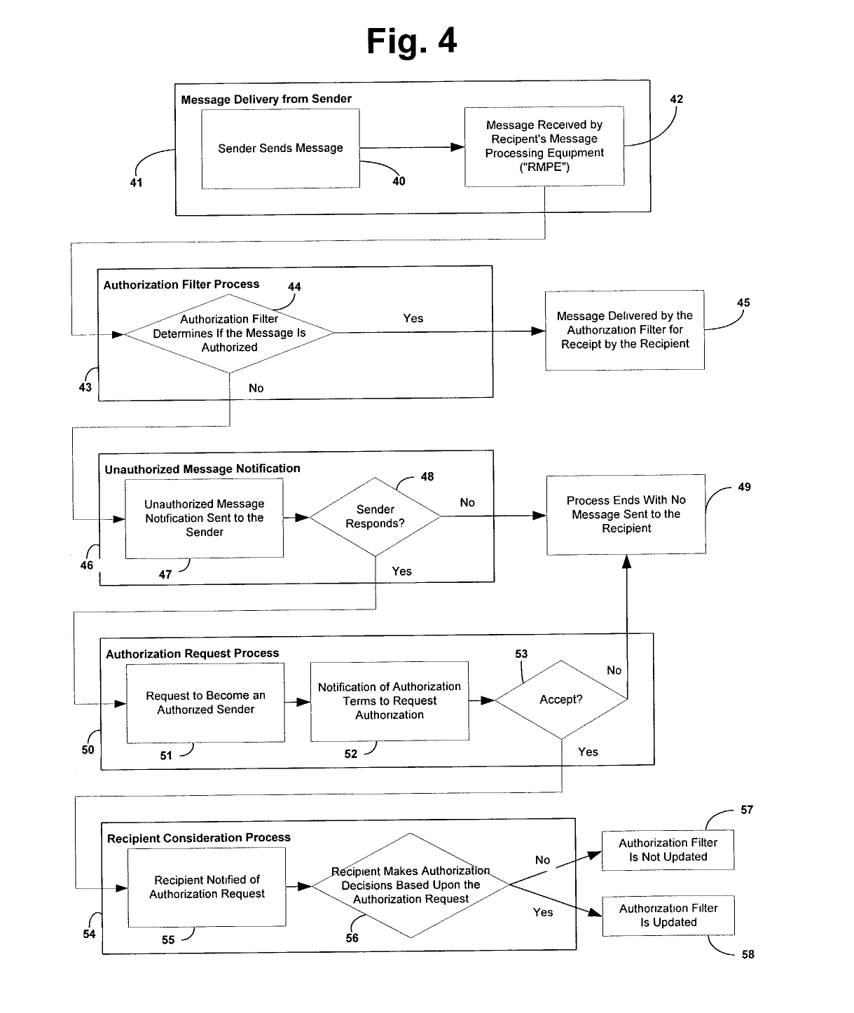

With reference to FIG. 4, the system and method for the present invention begins with a message delivery 41 with a message being sent by a sender in a step 40 through a general communications medium. As discussed above, a message can be transmitted through various means, including internet, WAN, LAN, wired telephone connection, wireless telephone connection, and combinations of these. Through the general communications medium, the message is received by a RMPE in a step 42.

The RMPE may reside in a variety of places depending upon the type of message system used by the message receiver. While the RMPE may reside in a variety of locations, it may always reside prior to the last message processor that delivers the message for reading by the message receiver. However, the particular location is unimportant for the purpose of this patent application.

Upon receipt of the message by the RMPE, the message is processed in an AF process 43 containing a decision step 44. Depending upon the specific configuration of the message system, the AF may also be a component of the RMPE, as illustrated in FIG. 2. It should be noted that the AF can be implemented as a single generalized filter for a number of users, or preferably as a separate filter for each user, reflecting the authorization preferences of the individual user. It is contemplated that each user has a profile associated with their email system that identifies the AF and the specific parameters chosen for the filters. For example, a user can have a number of AFs that can be selectively used at different times or for different purposes. The AF is the component of the system and method of the present invention that determines whether a message should be classified as authorized or unauthorized according to the specifications preferably set by the individual message receiver.

The AF processes the message by determining the specific variables of various parameters contained in the message. Such parameters include, for example, the name of the sender, the email address of the sender, the screen name of the sender, the telephone number of the sender, the Internet Protocol (“IP”) address of the sender, the title of the message, the content of the message or technical specifications of the message, such as type of mail server used, date of message delivery or time of message delivery. The specific variables of these parameters are compared to those defined in the individual message receiver's AF to determine authorization as illustrated in decision step 44.

The AF may include any combination of various types of white list and black list filters that were discussed above. The initial implementation of the filters provide pre-authorization to a given list of senders based on the above mentioned message criteria. It is contemplated, for example, that standard filter configurations can be made available for users that obtain new email accounts. The standard configurations can then be appended to reflect the individual user's authorization preferences.

The AF may include any combination of the various filters noted above, in addition to any other conventional filter not defined above which may be used to determine the authorization status. While individual filters may define a message as either authorized or unauthorized, an individual recipient may determine to have a message defined as authorized or unauthorized based upon a composite of responses by each individual filter. For example, while a general shared sender-based blacklist filter may classify a message as unauthorized, if another filter classifies the same message as authorized, then the message may overall be classified as authorized. The ultimate classification of the message may depend upon the particular specification of the individual message receiver in setting up the hierarchy of the filters.

As another example, receipt of an unauthorized message according to one of the various white lists and/or black lists described above may cause the sender information to be added to one or more black lists. If at some future point the sender becomes authorized, the present invention permits the sender information in one or more black lists to be removed and added to one or more of the white lists. While this process can be accomplished manually, it is preferred that the process occurs automatically to provide streamlined management of the user's email system. The AF may be constructed either in part or wholly by a message receiver, and it is envisioned that individual message receivers may manage these filters dynamically.

Upon the completion of processing by the AF, decision step 44 branches to an authorized or non-authorized path:

1. If the message is determined to be classified as authorized by the AF, decision step 44 branches to step 45 in which the message is delivered by the AF for receipt by the message receiver. Such delivery of the message includes, but is not limited to, standard delivery protocols used for the sending of messages, which in the case of email, includes but is not limited to, SMTP, POP3, IMAP or any other message delivery protocol to be developed. Other protocols may be used for forms of communication other than email.

2. If a message is determined to be classified as unauthorized by the AF, decision step 44 branches to step 47 in an Unauthorized Message Notification process 46 in which a message is generated. The message noting lack of authorization may be generated using standard database and email protocols and may include information regarding the sender of the original message, the message receiver of the original message, the reason for the generation of the unauthorized message notification message and the options for the sender to request authorization. The means of delivery of the message may include standard delivery protocols used for the sending of messages.

At the conclusion of this part of the process, the message receiver received only those messages that have met the overall authorized classification. All unauthorized messages, by definition, have been eliminated because of the processing by the AF. However, the message receiver may actually be willing to receive some messages that were classified as unauthorized. It is for this reason that the following elements are part of the present invention.

The Unauthorized Message Notification Message is a message sent to notify the sender that the message previously sent by the sender was classified as unauthorized. Such a message may include instructions for requesting authorization from the message receiver. In the present embodiment of the invention, with email as an example, the Unauthorized Message Notification Message may include an HTML link to a website that acts as a clearinghouse for Authorization Requests (“AR”). The sender can either respond or not, as indicated in a decision step 48. If the sender does not follow up on the Unauthorized Message Notification Message decision step 48 branches to step 49 and the overall process ends with no message ever being sent to the message receiver. It is expected that this may be the case the vast majority of the time with junk email. However, those senders who believe that the message receiver would be willing to authorize an authorization request may continue the process by clicking on the Authorization Request HTML link in the Unauthorized Message Notification Message with the computer's mouse or other input device, noted by decision on step 48 branching to the “YES” path and a step 51.

An Authorization Request (AR) process 50 begins with step 51 in which a party, who may or may not have been a prior message sender, provides at least one element of the basic identification information about the party, for example the party's name, the party's email address, the party's screen name or the party's telephone number. The provision of information permits so the message receiver to know to whom the message receiver may be granting authorization.

The second component of Authorization Request process 50 includes notifying the sender of authorization terms to request authorization (“ATRA”) in a step 52. The sender can agree to and accept the terms of the ATRA or not, illustrated in a decision step 53. Such ATRAs are intended to prevent anyone or anything from being able to request authorization without one or more conditions to such request. Specifically, a sender may be required to deposit an item of value into an escrow account of the message receiver. Such deposit may be considered a gesture of good faith or an enticement from the sender to have the AR considered and approved by the message receiver. As contemplated herein, an item of value may be monetary or non-monetary, and in the case of items of monetary value, such values may be positive, negative or zero, depending upon the choice of the individual message receiver. The actual transfer of items of value into escrow may be performed by a variety of methodologies, including but not limited to the electronic or physical transfer of items of value.

The ATRA is important to the present invention as it can be used by an individual message receiver to encourage or discourage senders from continuing the overall process of the present invention. Without wishing to be bound in theory, the assumption underlying the ATRA is that those message senders who are unwilling to put items into escrow are likely those who believe the message receiver would not value an AR from the sender, e.g., junk-emailer. Furthermore, those willing to deposit something of value may be willing to do so because of the potential for a zero-cost transaction. That is, a willing recipient can cause the escrowed item to be returned to the sender.

The particular order of the elements of the AR can be in any combination. The AR process may be considered completed if the Sender accepts or rejects the terms of the ATRA, as illustrated in a decision step 53. Upon the completion of AR process, there may be two outcomes represented by the YES and NO paths of decision step 53.

1. If a message sender does not accept the terms of the ATRA decision step 53 branches to a step 49 and the overall process ends with no message sent to the message receiver (Step 10.11).

2. If a message sender does accept the terms of the ATRA decision step 53 branches to a step 55 and the message receiver will be notified of the AR (Step 11).

A Message Receiver Consideration Process (“MRCP”) 54 begins with the message receiver receiving notification of the AR in step 55. This may potentially be the first time the message receiver becomes aware that the sender has tried to contact the message receiver.

A decision step 56 follows for an authorization decision (“AD”) in which the message receiver will decide whether to grant or deny authorization to the sender to send a message to the message receiver. If the recipient grants authorization, decision step 56 branches to step 58 in which the AF is updated. If the recipient denies authorization, decision step 56 branches to step 57 and the AF is not updated. Any decision to grant authorization to the sender may be reflected in the AF.

In another embodiment of the present invention, the message receiver may also have the option to return the item of value placed into the message receiver's escrow account as discussed above. By allowing the return of the items placed into an escrow account, the message receiver may be able to provide the opportunity for a zero-cost transaction to a particular sender by returning the escrow items to the sender. It is contemplated that message receivers may generally return escrow items to those senders granted authorization and keep escrow items from those senders not granted authorization, although it should be noted that these are independent decisions.

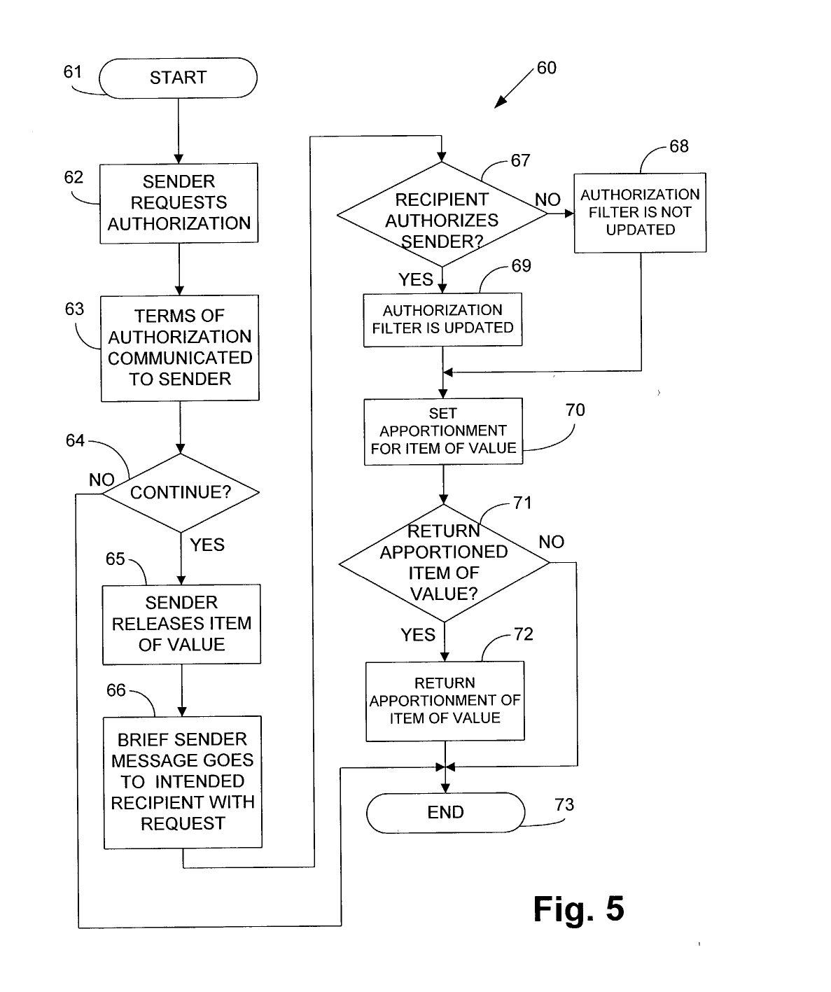

Referring now to FIG. 5, another embodiment of the present invention is illustrated in a flowchart shown generally as a flowchart 60. In this example, the sender may already be aware that the intended recipient has a procedure in place for obtaining authorization, and the sender may wish to specifically request authorization immediately without waiting to get a notification that they are unauthorized. The process starts in a step 61 with the sender immediately requesting authorization in a step 62. Step 62 can be implemented in a number of ways, such as the sender accessing an appropriate web site or emailing a specified address, for examples. The sender is apprised of the requirements for attempting to gain authorization with the intended recipient in a step 63. The authorization requirements can be tailored or set by the individual intended recipient, such as, for example, the sender must deposit $0.10 US in a specified escrow account to attempt authorization.

Once the sender is apprised of the conditions for attempting to gain authorization, the sender has the option of continuing with the attempt to gain authorization, illustrated in a decision step 64. If the sender does not agree to the terms and does not wish to continue, the process ends at step 73 after following the NO path from decision step 64. If the sender does agree to the terms and chooses to continue, decision step 64 branches to the YES path and continues with the process.

In a step 65, the sender releases an item of value according to the terms of the authorization attempt. For example, the sender may be required to deposit a monetary amount in an escrow account that can be disposed of according to the wishes of the intended recipient. Many other alternative treatments for items of value may be considered, for example the sender may be required to perform some task that could benefit the intended recipient or a designate third party. Whatever the case, the sender will put up a specified item of value for disposition by the intended recipient. At the same time as the release of the item of value in step 65, or at a point afterward, a brief message from the sender is transmitted to the intended recipient, as illustrated in a step 66. The message has the goal of convincing the intended recipient to provide authorization for the sender's complete message or for authorization for the sender to send messages in the future.

In a decision step 67, the intended recipient can decide whether to authorize the sender or not. If the intended recipient does not authorize the sender, or rejects the attempt by the sender to gain authorization, decision step 67 branches to the NO path and a step 68 in which no authorization filter update is conducted. Accordingly, by not updating the authorization filter, the sender remains unauthorized, as do messages sent by the sender. In this example, the sender is still able to continue to attempt to gain authorization, each time having to go through the process of releasing an item of value as in step 65, but the sender is not completely forbidden from attempts at authorization. It should be apparent that variations of treatment of the rejected authorization attempts can be implemented, such as permanently rejecting certain senders or content from attempting to gain authorization. In such instances, it is contemplated that the item of value would be kept by the intended recipient, even if they do not make a decision on authorization.

When the recipient authorizes the sender, following the YES path of decision step 67, the authorization filter is updated in a step 69. The update to the authorization filter adds information related to the sender, such as the sender's address or name, to the permissive lists such as the white lists discussed above. Once the sender is authorized, the message the sender wishes to send to the intended recipient can be forwarded directly to the recipient through the now permissive filter.

At about the same time the recipient chooses whether to authorized the sender, the recipient can also set an apportionment of the item of value to return, keep, or transfer to another entity in a step 70. For example, the recipient can choose for half of the benefit of the item of value to be retained by themselves, and the other half to be donated to a selected charitable cause. The apportionment can be the same or different for returned items of value as it is for retained items of value. In a decision step 71, the recipient can choose to return, in whole or part, the item of value to the sender. This arrangement provides for the potential of a zero-cost transaction for senders that the recipient wishes to authorize always, for example. If the apportioned item of value is to be returned, decision step 71 branches to the YES path and the portion or total of the item of value is returned to the sender in a step 72. If the item of value is retained by the recipient, decision step 71 branches to the NO path and terminates at a terminus 73.

The present invention has been explained with respect to specific arrangements and methods. However, it is noted that these arrangements and methods are merely illustrative of the principles of the present invention. Numerous modifications in form and detail may be made by those of ordinary skill in the art without departing from the scope of the present invention. Although this invention has been shown in relation to a particular preferred embodiment, it should not be considered so limited.

Such a filtering process may be used with any kind of communication, such as email, instant messaging, wireless short-messaging service, wireless email, voicemail, and real-time voice communications. The escrow process may take place at any location, such as at the ESP providing the email service, or a separate company which will only handle the escrow process. The ATRA notification message may also include substance in addition to the basic notification parameters, such as advertising, graphics, news, music and other forms of media. The escrow proceeds that the receiving party decides to not return to the sending party may be either kept in whole or in part by the receiving party or provided to any another designated party other than the sending party, for example, such as another family member, a friend, a school, a charity or, email service provider or an escrow agent.

Authorization may also be granted for varying periods of time or based upon the number of allowable messages to be sent by a sender.

What is claimed is:

1. A method for filtering messages comprising:
maintaining an authorization criteria for determining authorization status of a message from a sender;
receiving a message from the sender, the message having a message criteria;
determining whether the message is authorized or unauthorized based on a comparison of the message criteria with the authorization criteria;
notifying the sender of an unauthorized message that the unauthorized message is unauthorized when the message criteria does not satisfy the authorization criteria; and
notifying the sender of the unauthorized message how to attempt to satisfy the authorization criteria.

2. A method according to claim 1, further comprising accepting an item of specified value to permit the sender to attempt to satisfy the authorization criteria.

3. A method according to claim 1, wherein maintaining the authorization criteria further comprises maintaining a permissive list including information related to authorized messages.

4. A method according to claim 3,-wherein maintaining the authorization criteria further comprises maintaining a preventative list including information related to unauthorized messages.

5. A method according to claim 1, further comprising:
accepting an item of specified value on deposit; and
permitting the sender to attempt to satisfy the authorization criteria.

6. A method according to claim 3, further comprising:
accepting an item of specified value on deposit; and
permitting the sender to attempt to be included on the permissive list.

7. A method according to claim 5, further comprising:
notifying an intended recipient of the sender that is attempting to satisfy the authorization criteria; and
permitting the intended recipient to accept or reject the attempt by the sender.

8. A method according to claim 7, further comprising permitting the intended recipient to transfer a portion of the item of specified value to a selected entity.

9. A method according to claim 7, wherein:
maintaining the authorization criteria further comprises maintaining a preventative list including information related to unauthorized messages; and
adding related information to the preventative list when the intended recipient rejects the attempt by the sender to satisfy the authorization criteria.

10. A method according to claim 9, further comprising identifying the sender as an unauthorized sender when the intended recipient rejects the attempt by the sender to satisfy the authorization criteria.

11. A method according to claim 7, further comprising adding the sender criteria to the permissive list when the intended recipient accepts the attempt by the sender such that the sender becomes an authorized sender.

12. A method for filtering messages between a sender and an intended receiver over a communication medium, the method comprising:
developing a permissive criteria for forwarding a message from the sender to the receiver;
determining whether to forward to the receiver the message from the sender based on the permissive criteria;
informing the sender that the message has not been forwarded when the permissive criteria is not satisfied; and
accepting an item of specified value to permit the sender to attempt to satisfy the permissive criteria.

13. A method for filtering messages according to claim 12, further comprising notifying the intended receiver that the sender is attempting to satisfy the permissive criteria.

14. A method for filtering messages according to claim 12, further comprising providing an option to the intended receiver to transfer the item of specified value to a selected entity.

15. A method for attempting to satisfy an authorization criteria in a message filter, comprising:
accepting an item of specified value from a sender attempting to satisfy the authorization criteria;
notifying an intended receiver that the sender is attempting to satisfy the authorization criteria;
permitting the intended receiver to selectively accept or reject the attempt by the sender to satisfy the authorization criteria; and
updating the authorization criteria in the message filter in accordance with the selection by the intended receiver.

16. A method according to claim 15, further comprising:
permitting the intended receiver to select a transfer option for the item of specified value; and
transferring the item of specified value in accordance with the selection by the intended receiver.

17. A system for filtering messages, comprising:
a message filter list including information related to authorized message senders;
a system processor including a message processor portion coupled between a message sender and an intended message recipient, the message processor portion being operable to process a message from the message sender based on the message filter list and determine whether the message is authorized; and
the system processor further including a notification processor portion coupled between the message sender and the intended message recipient, the notification processor portion being operable to notify at least one of the message sender and the intended message recipient of the determination that the message is unauthorized or that the message sender is attempting to become an authorized message sender, respectively.

18. A system according to claim 17, further comprising a message queue coupled to the system processor for holding the message from the message sender when the message processor portion determines that the message is unauthorized.

19. A system according to claim 17, further comprising a sender authorization request mechanism coupled to the system processor, the request mechanism being operable to transmit to the system processor a request by the message sender to become an authorized message sender when the message processor portion determines the message sender to be an unauthorized message sender.

20. A system according to claim 17, further comprising an intended recipient authorization mechanism coupled to the system processor, the authorization mechanism being operable to permit the intended recipient to authorize receipt of a message from an unauthorized message sender.

21. A system according to claim 17, further comprising a conditional transfer deposit mechanism coupled to the system processor, the deposit mechanism being operable to hold an item of value in escrow and release the item upon selection by the intended recipient.

22. A system according to claim 17, wherein the message filter list further comprises a permissive list and a preventative list, the permissive list including the information related to authorized message senders, and the preventative list including information related to unauthorized message senders.

23. A system according to claim 17, wherein the notification to the message sender includes information on how to apply to become an authorized message sender.

24. A system according to claim 20, wherein the message processor portion is further operable to update the message filter list based on the authorization by the intended recipient.

25. A processor device programmed to execute instructions for filtering messages, the instructions comprising:
a first code section for maintaining an authorization criteria for determining authorization status of a message from a sender;
a second code section for receiving a message from the sender, the message having a message criteria;
a third code section for determining whether the message criteria satisfies the authorization criteria based on a comparison of the message criteria with the authorization criteria;
a fourth code section for notifying the sender of an unauthorized message that the unauthorized message was not delivered; and
a fifth code section for notifying the sender of the unauthorized message how to apply for authorization status for the message.

26. A storage media capable of storing program instructions executable to filter messages, the program instructions comprising:
a first code section for maintaining an authorization criteria for determining authorization status of a message from a sender;
a second code section for receiving a message from the sender, the message having a message criteria;
a third code section for determining whether the message criteria satisfies the authorization criteria based on a comparison of the message criteria with the authorization criteria;
a fourth code section for notifying the sender of an unauthorized message that the unauthorized message was not delivered; and
a fifth code section for notifying the sender of the unauthorized message how to apply for authorization status for the message.

27. A communication network for transmitting and receiving messages, the network having one or more nodes comprising:
a message filter list including information related to authorized message senders;
a system processor including a message processor portion coupled between a message sender and an intended message recipient, the processor being operable to process a message from the message sender based on the message filter list and determine whether the message is authorized; and
the system processor further including a notification processor portion coupled between the message sender and the intended message recipient, the notification processor portion being operable to notify at least one of the message sender and the intended message recipient of the determination that the message is unauthorized or that the message sender is attempting to become an authorized message sender, respectively.
